(19) United States
(12) Patent Application Publication
(10) Pub. No.: US 2017/0007943 A1
(43) Pub. Date: Jan. 12, 2017

(54) CONTACT TRAY FOR A MASS TRANSFER COLUMN AND METHOD INVOLVING SAME

(71) Applicant: Koch-Glitsch, LP, Wichita, KS (US)

(72) Inventor: IZAK NIEUWOUDT, Wichita, KS (US)

(73) Assignee: Koch-Glitsch, LP, Wichita, KS (US)

(21) Appl. No.: 15/200,184

(22) Filed: Jul. 1, 2016

Related U.S. Application Data
(60) Provisional application No. 62/190,034, filed on Jul. 8, 2015.

(51) Int. Cl. B01D 3/16; B23P 15/00

(52) U.S. Cl. CPC B01D 3/163; B23P 15/001

(57) ABSTRACT

A fixed valve contact tray for use in a mass transfer or heat exchange column and having a plurality of fixed valves distributed across a tray deck of the contact tray. Each of the fixed valves has a valve cover that is wider than and extends outwardly beyond an underlying opening in the tray deck, a perimeter region of the valve cover that is beveled downwardly, and a boundary region of the opening that is raised above a plane of the tray deck.

### BACKGROUND OF THE INVENTION

The present invention relates generally to columns in which mass transfer and heat exchange occur and, more particularly, to contact trays for use in such columns to facilitate interaction between fluid streams flowing within the columns and to methods of fabricating the contract trays.

As used herein, the term “mass transfer column” refers to a column in which mass transfer and/or heat exchange occur. Examples of mass transfer columns include distillation, absorption, stripping, and extraction columns.

Various types of trays are commonly used in mass transfer columns to promote contact and mass transfer between ascending and downwardly flowing fluid streams. The ascending fluid is typically vapor and the descending fluid is typically liquid, although liquid-liquid and gas-liquid systems are also known. Each tray normally extends horizontally across substantially the entire horizontal cross section of the column and is supported around its perimeter by a ring welded to the inner surface of the circular column wall or shell. A number of trays are positioned in this manner with a uniform vertical spacing between adjacent trays. The trays may be located in only a portion of the column to perform one part of a multi-step process occurring with the column. Alternatively, the trays may fill substantially the entire open area within the column.

Trays of the type described above contain one or more downcomers that are positioned at openings in the tray deck to provide passageways for liquid to descend from one tray to an adjacent lower tray. Prior to entering the downcomer, the liquid on the tray deck interacts with ascending vapor that passes through openings provided in selected portions of the tray deck. Those areas of the tray deck containing vapor openings are commonly referred to as “active” areas because of the vapor and liquid mixing and frothing that occurs above those areas of the tray.

The vapor openings in the tray deck can be simple sieve holes or can be formed as part of fixed or moveable valves. Conventional valves have valve covers supported over the opening in the tray deck by attachment legs. In fixed valves, the valve cover is fixed against vertical movement. In moveable valves, the valve cover is able to move up and down in response to variations in vapor or fluid flow rates through the opening. The valve cover functions to shield the opening in both the fixed and moveable valves against undesirable weeping of fluid downwardly through the opening and to laterally direct the vapor or other fluid that has ascended through the opening for enhanced interaction with the fluid flowing along the tray deck. In fixed and moveable valves of the type where the valve cover and attachment legs are separately fabricated and then fastened to the tray deck, it is known to make the valve cover larger than the opening so that it extends beyond the perimeter of the opening to facilitate shielding of the opening and redirection of the ascending fluid. In certain types of fixed valves, the valve cover and attachment legs are formed from the tray deck in a punching operation that leaves the lower ends of the attachment legs connected to the tray deck. In these types of fixed valves, the valve cover has the same dimensions as the opening in the tray deck from which the valve cover was formed. As a result, the benefits obtainable with a valve cover that extends beyond the opening have not been realized and a need has arisen for a method allowing fabrication of such a valve.

### SUMMARY OF THE INVENTION

In one aspect, the present invention is directed to a contact tray for use in a mass transfer column. The contact tray comprises a generally planar tray deck and a plurality of fixed valves distributed across the tray deck. Each of the fixed valves comprises an opening that extends through the tray deck to allow for passage of fluid through the tray deck and a valve cover supported by attachment legs at a fixed location above the opening. The attachment legs have lower ends that are integral with the tray deck. The valve cover and at least a portion of the attachment legs extend outwardly beyond an outer perimeter of the underlying opening.

In another aspect, the present invention is directed to a method of forming a fixed valve in a contact tray for use in a mass transfer column. The method includes the steps of: providing a rigid sheet having a planar upper surface; deforming a portion of the sheet upwardly to create an embossed valve cover and attachment legs, the attachment legs having first ends connected to the valve cover and opposed second ends; separating the embossed valve cover and attachment legs from the upwardly deformed portion of the sheet while leaving the second ends of the attachment legs connected to the sheet and thereby creating an opening in the sheet underlying the separated valve cover and the attachment legs and a raised boundary layer of the sheet along a perimeter of the opening; and depressing the raised boundary layer of the sheet to reduce a cross-sectional area of the opening such that the valve cover and at least a portion of the attachment legs extend outwardly beyond the opening with the reduced cross-sectional area.

### BRIEF DESCRIPTION OF THE DRAWINGS

In the accompany drawings that form part of the specification and in which like reference numerals are used to indicate like components in the various views:

FIG. 1 is a fragmentary, perspective view of a column in which mass transfer and/or heat exchange are intended to occur and in which a portion of a shell of the column is broken away to show one embodiment of fixed valve contact trays of the present invention;

FIG. 2 is an enlarged, perspective view of the contact trays in the column shown in FIG. 1;

FIG. 3 is a fragmentary, perspective view of one of the contact trays of FIGS. 1 and 2, showing valves of the contact tray on a further enlarged scale;

FIG. 4 is a fragmentary, perspective view of one of the contact trays showing one of the fixed valves as it is in the process of being formed in the contact tray;

FIG. 5 is a top plan view showing the valve in the same stage of being formed as in FIG. 4;

FIG. 6 is a side elevation view of the valve shown in FIGS. 4 and 5 taken in vertical section along line 6-6 of FIG. 5 in the direction of the arrows;

FIG. 7 is a fragmentary, perspective view showing the valve of FIGS. 4-6 in a subsequent stage of being formed;

FIG. 8 is a top plan view showing the valve in the same stage of being formed as in FIG. 7;

FIG. 9 is a side elevation view of the valve shown in FIGS. 7 and 8 taken in vertical section along line 9-9 of FIG. 8 in the direction of the arrows;

FIG. 10 is an end elevation view of the valve rotated 90° from the view shown in FIG. 9 and taken in vertical section along line 10-10 of FIG. 9 in the direction of the arrows;

FIG. 11 is a fragmentary, perspective view showing the valve of FIGS. 4-10 in a completed form;

FIG. 12 is a top plan view of the completed valve;

FIG. 13 is a side elevation view of the completed valve;

FIG. 14 is an end elevation view of the completed valve;

FIG. 15 is an end elevation view of the completed valve showing the opposite end from that shown in FIG. 14;

FIG. 16 is a bottom plan view of the completed valve;

FIG. 17 is an enlarged side elevation view of the completed valve taken in vertical section along line 17-17 of FIG. 12 in the direction of the arrows;

FIG. 18 is an end elevation view of the completed valve taken in vertical section along line 18-18 of FIG. 17 in the direction of the arrows; and

FIG. 19 is a graph showing the comparative performance of a fixed valve contact tray of the present invention against a fixed valve contact tray lacking the inventive features.

### DETAILED DESCRIPTION

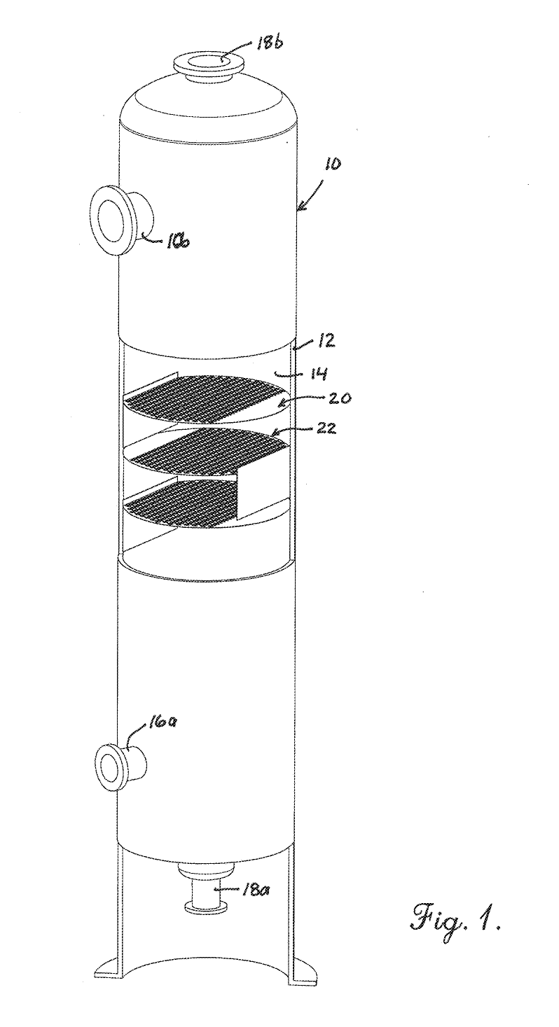

Turning now to the drawings in greater detail and initially to FIG. 1, a mass transfer column suitable for use in mass transfer or heat exchange processes is represented generally by the numeral 10. The column 10 may include an upright, external shell 12 that may be generally cylindrical in configuration, although other configurations, including polygonal, are possible and are within the scope of the present invention. The shell 12 may be of any suitable diameter and height and may be constructed from one or more rigid materials that are desirably inert to, or are otherwise compatible with, the fluids and conditions present during operation of the column 10.

The column 10 may be of a type used for processing fluid streams, typically liquid or vapor streams, to obtain fractionation products or to otherwise cause mass transfer or heat exchange between the fluid streams. For example, the column 10 may be one in which crude atmospheric, lube vacuum, crude vacuum, fluid or thermal cracking fractionating, coker or visbreaker fractionating, coke scrubbing, reactor off-gas scrubbing, gas quenching, edible oil deodorization, pollution control scrubbing, or other processes occur.

The shell 12 of the column 10 defines an open internal region 14 in which the desired mass transfer or heat exchange between the fluid streams occurs. In one implementation, the fluid streams may comprise one or more ascending vapor streams and one or more descending liquid streams. In other implementations, the fluid streams may comprise substantially any combination of ascending or descending liquid streams or ascending or descending vapor streams.

One or more fluid streams may be directed into the column 10 through any number of feed lines 16, such as lower feed lines 16a or upper feed lines 16b, positioned at appropriate locations along the height of the column 10. In one implementation, vapor streams may be generated within the column 10 rather than being introduced into the column 10 through the feed lines 16a, 16b. One or more fluid streams may be directed out of the column 10 through any number of takeoff lines 18, such as lower takeoff line 18a and upper takeoff line 18b. In one implementation, liquid may be introduced through upper feed line 16b, descend through the column 10, and be removed through lower takeoff line 18a, while vapor may be introduced through lower feed line 16a, ascend through the column 10, and be removed through upper takeoff line 18b.

Other column components that would typically be present, such as reflux stream lines, reboilers, condensers, vapor horns, liquid distributors, and the like, are not illustrated in the figures because they are conventional in nature and an illustration of these components is not believed to be necessary for an understanding of the present invention.

In accordance with the present invention, a plurality of pairs of fixed-valve contact trays 20 and 22 is positioned within the open internal region 14 of the column 10 to facilitate interaction of the fluids flowing within the open internal region 14. The trays 20 and 22 extend generally horizontally across the entire cross-section of the column 10 and are arranged in an alternating fashion such that each tray 20 overlies and is vertically adjacent to one of the trays 22. The specific design of each tray 20 and 22 can be varied while remaining within the scope of the present invention.

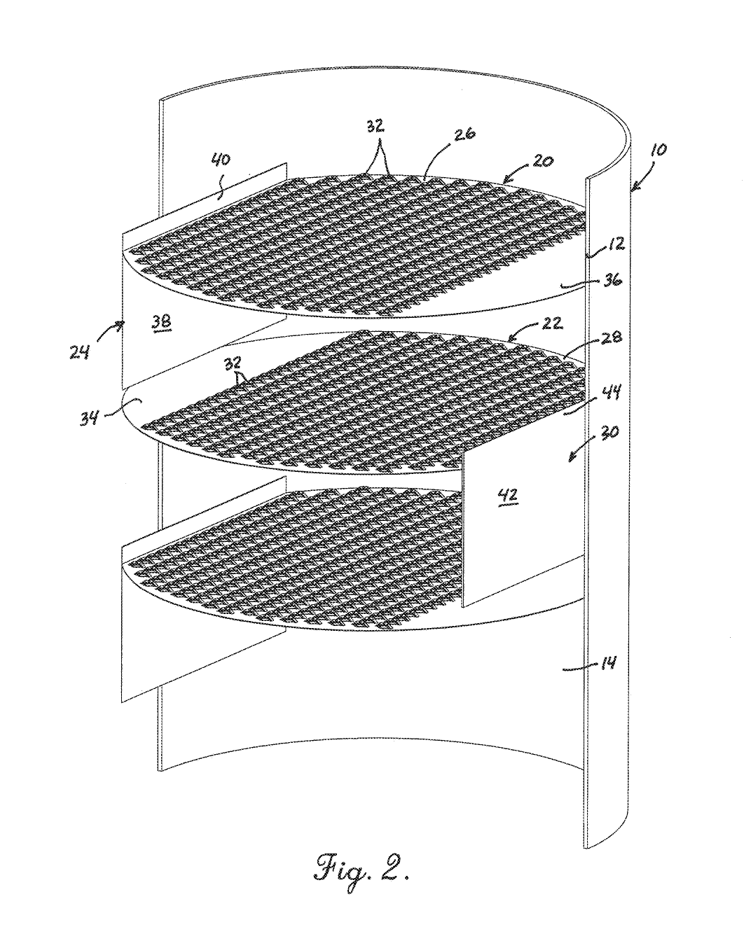

In the illustrated embodiment of FIGS. 1-2, the trays 20 and 22 are constructed to form a single-pass fluid flow arrangement in which the descending fluid flows from end-to-end opposite flow directions on each tray 20 and 22. Each tray 20 has a side downcomer 24 that is positioned at one end of a tray deck 26 that is normally formed from interconnected tray panels. The side downcomer 24 receives and removes the descending fluid from the tray deck 26 and delivers it to one end of a tray deck 28 of a paired underlying tray 22. The fluid then flows across the tray deck 28 in an opposite direction to a side downcomer 30 that is positioned at an opposite end of the tray deck 28. The fluid enters the side downcomer 30 and is delivered to the tray deck 26 of the next underlying tray 20. This flow pattern is repeated on each of the lower pairs of trays 20 and 22. Although the trays 20 and 22 are illustrated as being constructed for single-pass fluid flow, the invention encompasses trays constructed for multi-pass flow.

Fixed valves 32 are positioned in a preselected pattern on some portions of the tray decks 26 and 28 of the trays 20 and 22 to allow vapor or another fluid to ascend through the tray decks 26 and 28 and interact with flowing across the upper surface of the tray decks 26 and 28. The area of the tray decks 26 and 28 containing these fixed valves 32 is normally referred to as the active area of the trays 20 and 22.

The area of the tray deck 28 underlying the side downcomer 24 of the overlying tray 20 comprises an inlet panel 34 and is normally imperforate or has shielded flow passages that impede or prevent the descending fluid from passing through the inlet panel 34. Similarly, the area of the tray deck 26 underlying the side downcomer 30 of the overlying tray 22 comprises an inlet panel 36 that is imperforate or has shielded flow passages.

The side downcomer 24 of each tray 20 comprises a wall 38 that extends in a chordal fashion across the open internal region 14 of the column 10. The upper portion of the wall 38, or a separate piece attached to the wall 38, extends upwardly above the tray deck 26 to form an inlet weir 40 that causes liquid to accumulate on the tray deck 26 before spilling over the weir 40 and entering the side downcomer 24. A lower portion of the wall 38 is spaced above the underlying tray deck 28 or contains flow openings (not shown) to allow fluid to exit the side downcomer 24 and flow along the upper surface of the tray deck 28 before entering the side downcomer 30 at the opposite end of the tray deck 26.

Similarly, the side downcomer 30 on each tray 22 comprises a chordal wall 42 that has a lower portion that is spaced above the underlying tray deck 26 or contains flow openings (not shown) to allow fluid the exit the side downcomer 30 and flow along the upper surface of the tray deck 26. An upper portion of the wall 42, or a separate piece attached to the wall 42, extends upwardly above the tray deck 28 to form an inlet weir 44. While each of walls 38 and 42 is illustrated as planar and vertically-extending, stepped, sloped or multi-chordal walls or other constructions are within the scope of the invention.

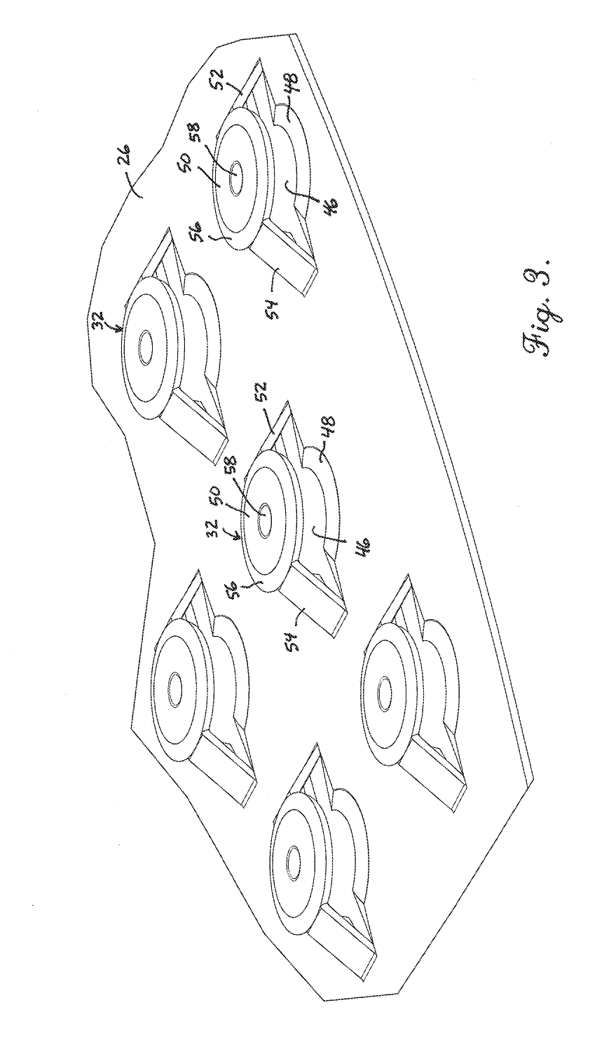

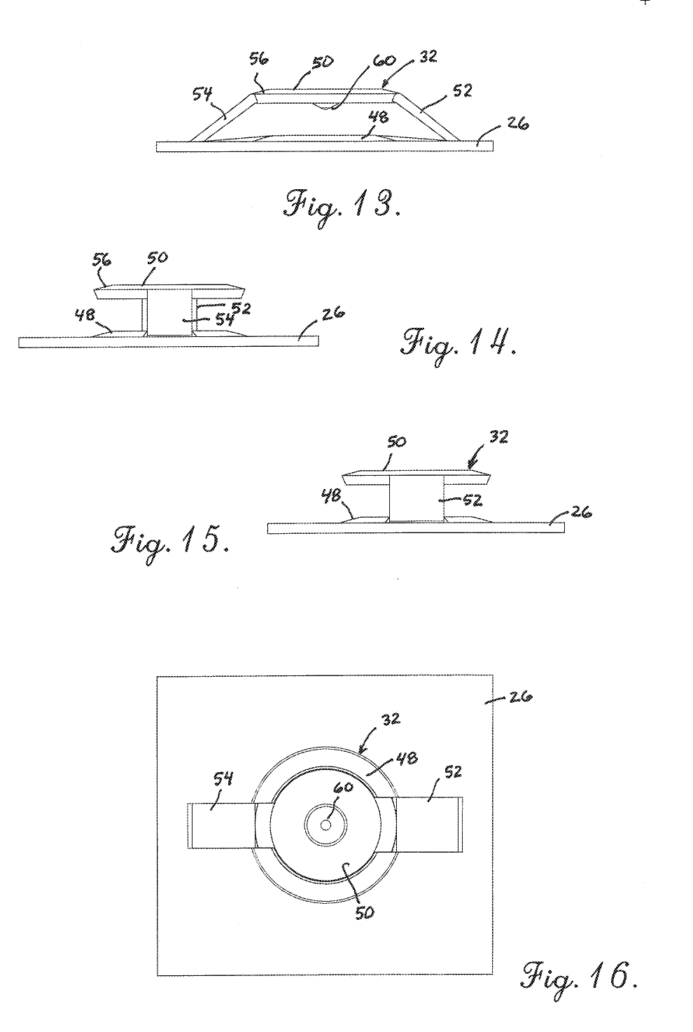

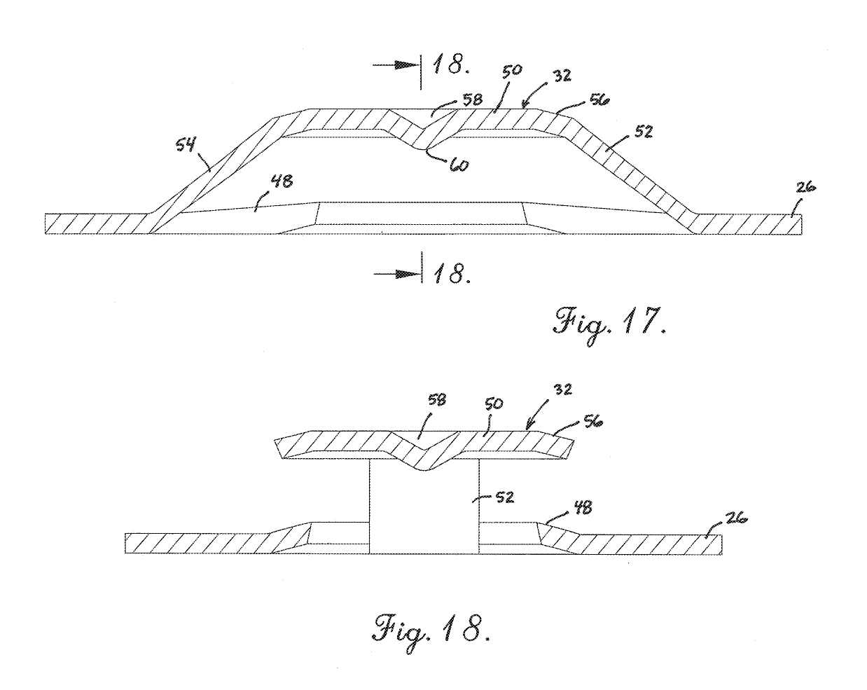

Turning now to FIGS. 3 and 13-18, each of the fixed valves 32 on tray deck 26 comprises an opening 46 that extends through the tray deck 26 to allow for passage of fluid through the tray deck 26 and a raised boundary region 48 in the tray deck 26 along a perimeter of the opening 46. Each fixed valve 32 also includes a valve cover 50 supported by attachment legs 52 and 54 at a fixed, preselected location above the opening 46. Two attachment legs 52 and 54 are used in the illustrated embodiment to support the valve cover 48, but additional attachment legs could be used if desired. The attachment legs 52 and 54 in the illustrated embodiment are inclined and are located at opposite ends of the valve cover 50. Upper ends of the attachment legs 52 and 54 are attached to and are integral with an edge of the valve cover 50. Lower ends of the attachment legs 52 and 54 are attached to and are integral with the tray deck 26. The angle of inclination of each attachment leg 52 or 54 in one embodiment is between 20° and 80°, with reference to the plane of the tray deck 26 in the direction facing the opposite attachment leg 52 or 54.

As can be seen by additional reference to FIG. 12, attachment leg 52 has a width that is greater than that of the attachment leg 54, with both attachment legs 52 and 54 having a width less than that of the valve cover 50. The fixed valve 32 is oriented on the tray deck 26 so that the attachment legs 52 and 54 are aligned in the general direction of fluid flow along the upper surface of the tray deck 26, with the wider attachment leg 52 located at the upstream side of the fixed valve 32.

The valve cover 50 in the illustrated embodiment is circular with a downwardly-beveled outer perimeter region 56 and a center dimple 58 that forms a downwardly-extending protrusion 60 (FIG. 13) on an undersurface of the valve cover 50. The valve cover 50 lies in a plane that is parallel to that of the tray deck 26, but the valve cover 50 may be inclined, such as in an upward direction in the general direction of fluid flow on the upper surface of the tray deck 26. Each of the fixed valves 32 on tray deck 28 are of the same construction as those on the tray deck 26.

The valve cover 50 and attachment legs 52 and 54 are formed in a manner that causes the valve cover 50 and at least a portion of the attachment legs 52 and 54 to extend outwardly beyond an outer perimeter of the underlying opening 46 to more effectively shield the opening against the detrimental downward weeping of fluid through the opening 46.

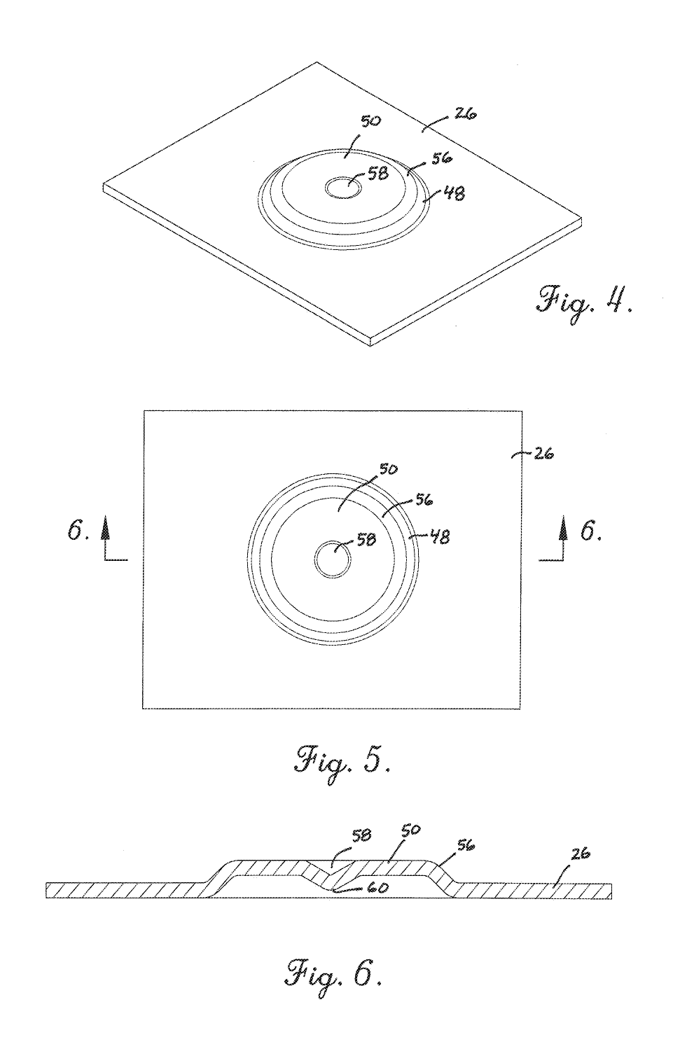

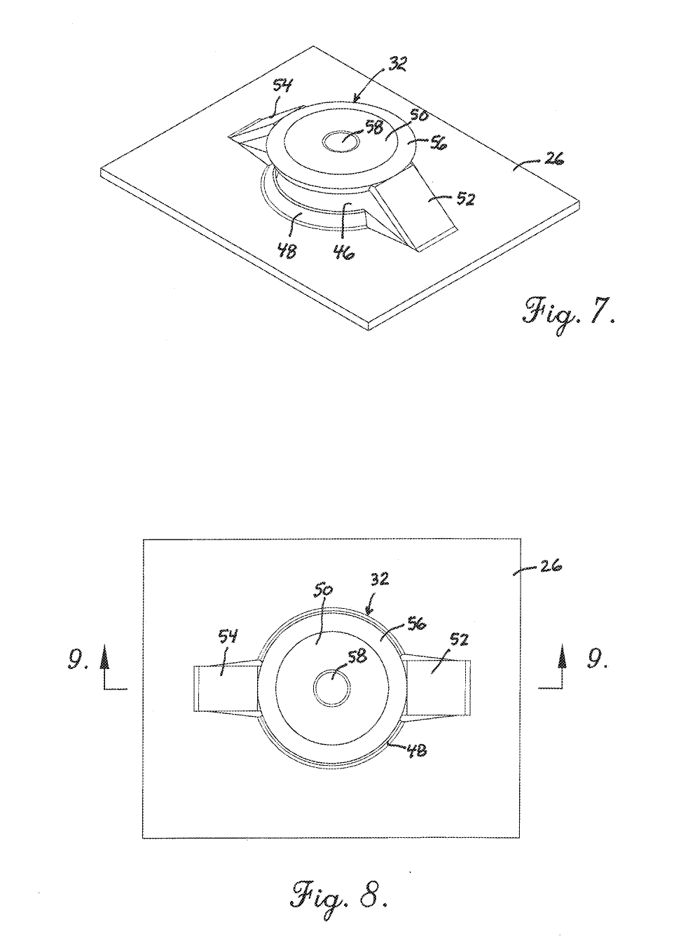

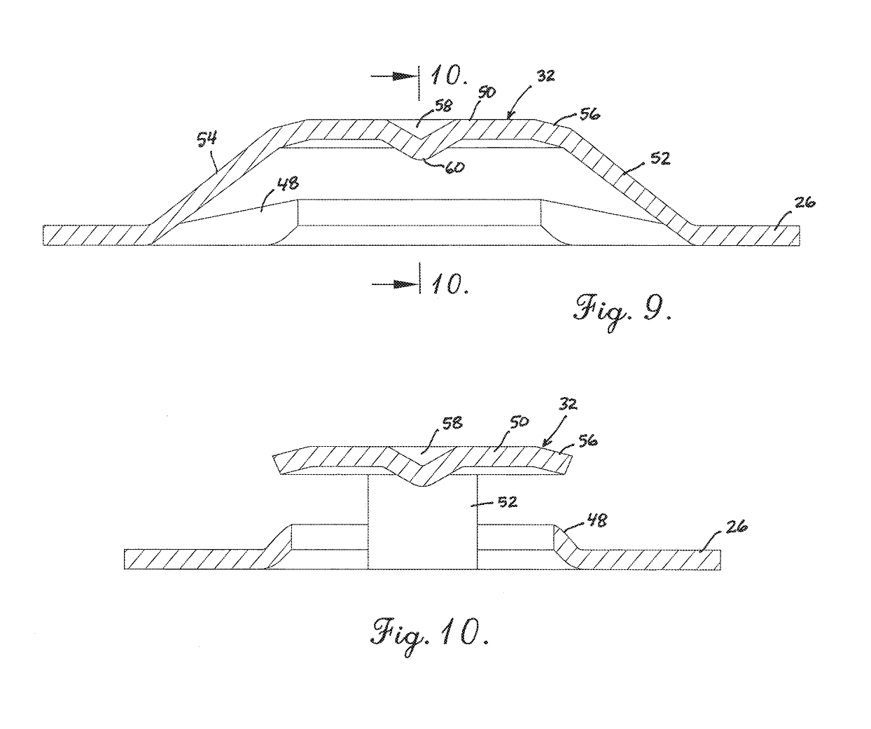

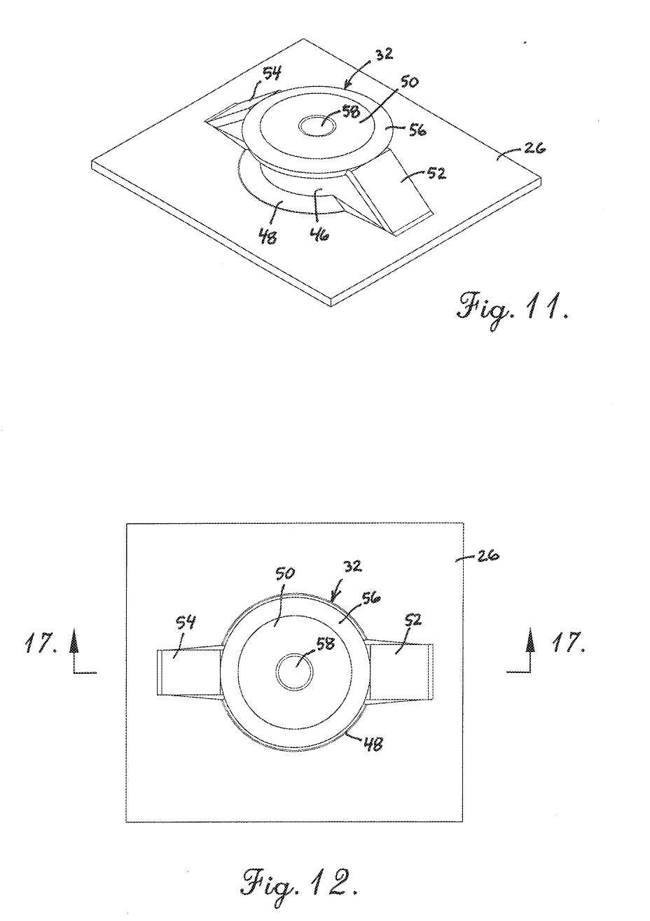

Turning to FIGS. 4-10, the method of forming the fixed valves 32 comprises providing a rigid sheet material such as a metal or metal alloy that will be used as the tray deck 26 or 28. A portion of the sheet is deformed upwardly using suitable forming techniques to initially form an embossed valve cover 48 having the beveled perimeter region 56 and optional dimple 58. At this initial stage of the stretching and deformation of the sheet, the entire perimeter region 56 of the valve cover 48 remains attached to the sheet. Further deformation of the sheet causes the boundary region 48 to be formed and elevated above the plane of the sheet, while remaining attached to the perimeter region 56 of the valve cover 48, and also causes the attachment legs 52 and 54 to be formed as embossed portions of the sheet while remaining attached to the perimeter region 56.

After the sheet has been deformed sufficiently to form the embossed boundary region 48, the sheet is cut to separate the embossed valve cover 50 and attachment legs 52 and 54 from the upturned boundary region 48, while leaving the lower ends of the attachment legs connected to the sheet. This cutting of the sheet creates the perimeter of the opening 46. Once the valve cover 50 and all but the lower ends of the attachment legs 52 and 54 have been freed from the sheet by the cutting operation, they may be moved further upwardly to place the valve cover 50 at a preselected location above the opening 46 to provide the desired clearance in the vertical spacing between them.

The fabrication process includes depressing the raised boundary region 48 along the perimeter of the opening 46 downwardly toward the plane of the sheet to decrease the area of the opening 46 and thereby cause the valve cover 50 and attachment legs 52 and 54 to extend outwardly beyond the raised boundary region 48. This can be seen in FIG. 10 which shows the raised boundary region 48 depressed from the fully stretch and deformed position it was in when the embossed valve cover 50 and attachment legs 52 and 54 were separated from the sheet. FIG. 18 shows the raised boundary region 48 depressed even further, while remaining elevated above the plane of the sheet, to further decrease the area of the opening 48 and further increase the area of the valve cover 50 and attachment legs 52 and 54 that extend beyond the opening 46. The boundary region 48 can be fully returned to the plane of the sheet, i.e, of the tray deck 26, but in most embodiments of the invention it will remain at least partially elevated to facilitate the vapor handling capacity of the trays 20 and 22.

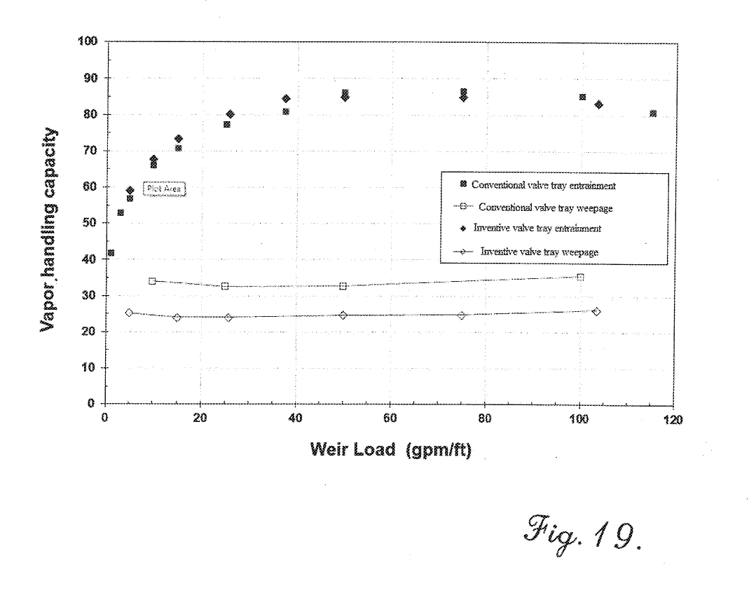

It has been found through comparative testing that forming the fixed valves 32 with the valve cover 50 extending beyond the opening 46, the perimeter region 56 of the valve cover 50 beveled downwardly, and the boundary region 48 of the opening 46 raised above the plane of the tray deck 26 or 28 reduces the entrainment of liquid in the vapor ascending through the fixed valves 32 and decreases the weeping of liquid downwardly through the fixed valves. In the comparative testing, the fixed valves 32 of the present invention were tested against conventional valves that lacked the features described above but were otherwise similar in construction. The results of the testing are set forth in FIG. 19.

From the foregoing, it will be seen that this invention is one well adapted to attain all the ends and objectives hereinabove set forth together with other advantages that are inherent to the structure.

It will be understood that certain features and subcombinations are of utility and may be employed without reference to other features and subcombinations. This is contemplated by and is within the scope of the invention.

Since many possible embodiments may be made of the invention without departing from the scope thereof, it is to be understood that all matter herein set forth or shown in the accompanying drawings is to be interpreted as illustrative and not in a limiting sense.

What is claimed is:

1. A contact tray for use in a mass transfer column, said contact tray comprising:
a generally planar tray deck; and
a plurality of fixed valves distributed across the tray deck, each of said fixed valves comprising an opening that extends through the tray deck to allow for passage of fluid through the tray deck and a valve cover supported by attachment legs at a fixed location above said opening, said attachment legs having lower ends that are integral with the tray deck,
wherein said valve cover and at least a portion of said attachment legs extend outwardly beyond an outer perimeter of the underlying opening.

2. The contact tray as set forth in claim 1, wherein said attachment legs are inclined.

3. The contact tray as set forth in claim 1, wherein said attachment legs comprise first and second attachment legs aligned at opposite ends of said valve cover.

4. The contract tray as set forth in claim 1, wherein said valve cover is circular.

5. The contact tray as set forth in claim 1, wherein said valve cover has a centrally-positioned protrusion extending downwardly from an undersurface of the valve cover.

6. The contact tray as set forth in claim 1, wherein said valve cover has a beveled outer perimeter.

7. The contact tray as set forth in claim 1, wherein said attachment legs comprise first and second attachment legs aligned at opposite ends of said valve cover and wherein both of said first and second attachment legs have a width less than that of the valve cover.

8. The contact tray as set forth in claim 7, wherein one of said first and second attachment legs has a greater width than the other of said first and second attachment legs.

9. The contact tray as set forth in claim 1, including a raised boundary region in the tray deck along a perimeter of each of the openings.

10. The contact tray as set forth in claim 1, wherein said attachment legs are inclined at an angle between 20° and 80°.

11. A method of forming a fixed valve in a contact tray for use in a mass transfer column, said method comprising the steps of:
providing a rigid sheet having a planar upper surface;
deforming a portion of the sheet upwardly to create an embossed valve cover and attachment legs, said attachment legs having first ends connected to the valve cover and opposed second ends;
separating the embossed valve cover and attachment legs from the upwardly deformed portion of the sheet while leaving the second ends of the attachment legs connected to the sheet and thereby creating an opening in the sheet underlying the separated valve cover and the attachment legs and a raised boundary region of the sheet along a perimeter of the opening; and
depressing the raised boundary region of the sheet to reduce a cross-sectional area of the opening such that the valve cover and at least a portion of the attachment legs extend outwardly beyond the opening with the reduced cross-sectional area.

12. The method of claim 11, wherein said step of deforming a portion of the sheet upwardly to create an embossed valve cover and attachment legs comprises creating first and second attachment legs that are inclined and are aligned at opposite ends of said valve cover.

13. The method of claim 11, including the step of forming a protrusion that is centrally-positioned and extends downwardly from an undersurface of the valve cover.

14. The method of claim 11, wherein said step of deforming a portion of the sheet upwardly comprises deforming said portion of the sheet upwardly by a vertical distance greater than a thickness of said sheet before said step of separating the embossed valve cover and attachment legs from the upwardly deformed portion of the sheet.

15. A contact tray for use in a mass transfer column, said contact tray comprising:
a generally planar tray deck; and
a plurality of fixed valves distributed across the tray deck, each of said fixed valves comprising an opening that extends through the tray deck to allow for passage of fluid through the tray deck and a valve cover supported by first and second legs at a fixed location above said opening, said valve cover and said first and second legs having been formed from a portion of the tray deck that was separated from and elevated above a remaining portion of the tray deck to create the underlying opening in the tray deck,
wherein said valve cover and said first and second legs have horizontal dimensions that extend outwardly beyond an outer boundary of the underlying opening.

16. The contact tray as set forth in claim 15, wherein said attachment legs are inclined at an angle between 20° and 80°.

17. The contact tray as set forth in claim 15, wherein said attachment legs comprise first and second attachment legs aligned at opposite ends of said valve cover and wherein both of said first and second attachment legs have a width less than that of the valve cover and one of said first and second attachment legs has a greater width than the other of said first and second attachment legs.

18. The contract tray as set forth in claim 15, wherein said valve cover is circular.

19. The contact tray as set forth in claim 15, wherein said valve cover has a centrally-positioned protrusion extending downwardly from an undersurface of the valve cover.

20. The contact tray as set forth in claim 15, including a raised boundary region in the tray deck along a perimeter of each of the openings.
